(19) United States
(12) Patent Application Publication
(10) Pub. No.: US 2021/0357876 A1
(43) Pub. Date: Nov. 18, 2021

(54) LOCATION-BASED EVENT NOTIFICATION APPLICATION

(71) Applicant: Barbara Jean Chapman, Cumming, GA (US)

(72) Inventor: Barbara Jean Chapman, Cumming, GA (US)

(21) Appl. No.: 15/930,787

(22) Filed: May 13, 2020

(51) Int. Cl. G06Q 10/10; G06F 9/54; H04W 4/029; H04L 29/08

(52) U.S. Cl. CPC G06Q 10/1095; G06F 9/542; H04L 67/025; H04W 4/029; G06F 9/546

(57) ABSTRACT

A system and method for a mobile system that provides real-time automated location-based alerts of time-based events is disclosed. The system includes a mobile application for defining an event record associated with a calendar appointment and for processing event records as event triggers and notification events occur; and a web server for maintaining a database of event records periodically provided to the mobile application for monitoring. The he mobile application sets an event record as being active when a trigger event occurs. The mobile application send a notification message to a recipient when a notification event associated with the active event record occurs. The active event record is deleted when a condition associated with the calendar event is satisfied before a notification event occurs.

### TECHNICAL FIELD

This application relates in general to a system and method for providing a mobile application-based notification function, and more specifically, to a system and method that provides automated location-based alerts of time-based events.

### BACKGROUND

Busy people of all types are trying to keep up with obligations that require them to be at a particular location at a specific time. Failure to make it to these locations as expected may lead to undesired consequences. These events may be as simple as making it home in a timely fashion to walk a dog or as important as a meeting at a client's office that may represent a huge business opportunity. Additionally, events like walking the dog occur every day, but may not occur at a specific time each day; rather, they occur a set number of hours after a triggering event, i.e. someone leaving home for work in the morning.

Many calendar and reminder applications exist that execute on computing platforms both large and small. In order to be effective, these applications require an automated mechanism to determine when a person leaves a specified location and/or determines when that person is currently expected to arrive at a location. Many of these specific events are not known until immediately before they are to happen and, even if known, are not convenient to enter into applications that may be able to take advance action that would eliminate or reduce any consequences of the person not making an event on time.

Therefore, a need exists for a mobile system that provides real-time automated location-based alerts of time-based events. Such a system may use both time- and location-based data for determining when an event may occur, as well as when a person is likely to be at a location to satisfy the event. Current calendar and reminder applications do not provide such flexibility and dynamic event-timing determination.

### SUMMARY

In accordance with the present invention, the above and other problems are solved by providing a system and method that provides real-time automated location-based alerts of time-based events according to the principles and example embodiments disclosed herein.

In one embodiment, the present invention is a system that provides real-time automated location-based alerts of time-based events. The system includes a mobile application for defining an event record associated with a calendar appointment and for processing event records as event triggers and notification events occur; and a web server for maintaining a database of event records periodically provided to the mobile application for monitoring. The he mobile application sets an event record as being active when a trigger event occurs. The mobile application send a notification message to a recipient when a notification event associated with the active event record occurs. The active event record is deleted when a condition associated with the calendar event is satisfied before a notification event occurs

In another embodiment, the present invention is a method that provides real-time automated location-based alerts of time-based events. The method creates an event record associated with a calendar appointment, stores the event record in a local database, transmits the event record to a web server, retrieves daily upcoming event records from the local database, identifies a start trigger event and notification event associated with the daily upcoming event records, stores the start trigger event and the notification event into a queue, when a trigger event occurs, marks the daily upcoming event records associated with the trigger event as an active event, and when a notification event occurs associated with the daily upcoming event records marked as active, generates a notification message and sends the notification message to a recipient.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiments disclosed may be readily utilized as a basis for modifying or designing other structures for carrying out the same purposes of the present invention. It also should be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system that provides real-time automated location-based alerts of time-based events according to the present invention.

FIG. 2 illustrates an example use of a system that provides real-time automated location-based alerts of time-based events according to the present invention.

FIG. 3a-c illustrates an example event embodiment useful in a system that provides real-time automated location-based alerts of time-based events according to the present invention.

FIG. 4 illustrates a computing system of software components that provides real-time automated location-based alerts of time-based events according to the present invention.

FIG. 5 illustrates a flowchart corresponding to a method performed by software components that provides real-time automated location-based alerts of time-based events according to the present invention.

FIG. 6 illustrates a generalized schematic of a programmable processing system utilized as the various computing components described herein to implement an embodiment of the present invention.

### DETAILED DESCRIPTION

This application relates in general a system and method for providing a mobile application notification function, and more specifically, to a system and method that provides real-time automated location-based alerts of time-based events according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specifications and claims are approximations that may vary depending upon the desired properties sought to be obtained by the present disclosure. At the very least, and not as an attempt to limit the application of the doctrine of equivalents to the scope of the claims, each numerical parameter should be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The term “user” refer to an entity, e.g. a human, using the Location Based Event Notification Application including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are included below in this application.

The term “invention” or “present invention” refers to the invention being applied for via the patent application titled “Location Based Event Notification Application.” Invention may be used interchangeably with “mobile application.”

The terms “communicate”, or “communication” refer to any component(s) connecting with any other component(s) in any combination in order to communicate and/or transfer data to and from any components and/or control any settings, within a Web server or mobile application

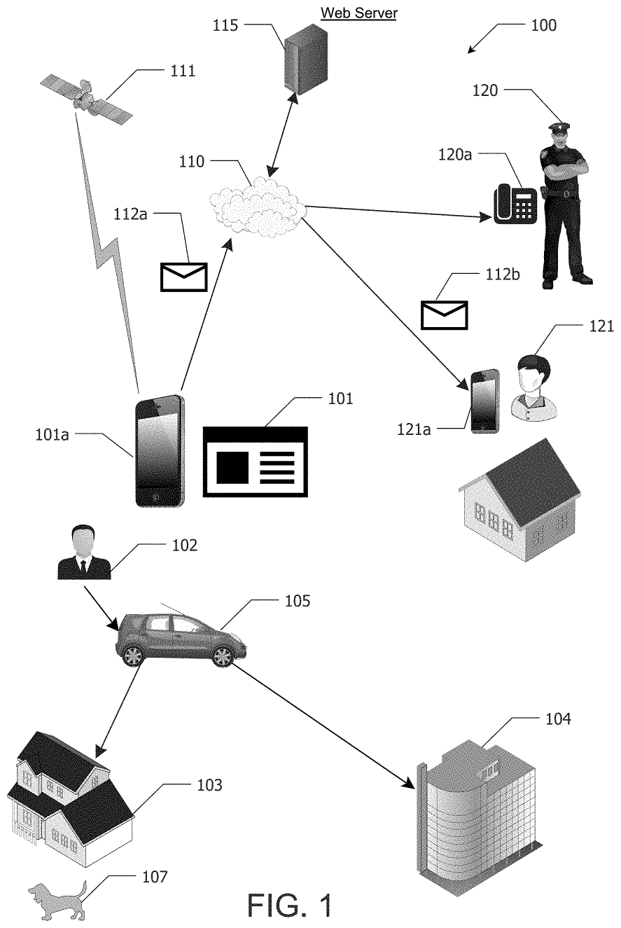

In general, the present disclosure relates a system and method that provides real-time automated location-based alerts of time-based events. To better understand the present invention, FIG. 1 illustrates an example embodiment for a system that provides real-time automated location-based alerts of time-based events according to the present invention. Mobile application 101 is executing on a smartphone 101a that is typically close to or is on the person of its user 102. The user 102 travels in his or her car 105 to go from work 104 to home 103 on a daily basis.

Smartphones 101a accurately determine location at any point in time based upon signals received from a Global Positioning Satellite (GPS) 111 or upon signals received from cell towers (not shown). A GPS receiver is typically included within the circuitry of smartphones 111 to receive a satellite signal that may be used to generate a location. Similarly, the smartphone 101a may receive signals from multiple cell towers and, using the positions of the cell towers, may determine a location using triangulation. Knowing the location of the user 102 at all times permits the mobile application 102 to use the data to readily determine whether or not the user will be at a specific location in time to satisfy an event.

On a typical weekday, the user 102 leaves his or her home 103 to go to an office 104 to perform a day's work. The user 102 may leave between 8:00 and 8:15 am each day; however twice a month, the user 102 works at home 103 until 10:30 am because he or she has an evening meeting that is considered part of the workday. One of the last things the user does before leaving is walk a dog, Minnie 107, as the neighborhood around his home 103 prohibits fencing.

Minnie 107 is a good dog that may be left alone in the home 103 for most of the day; however, Minnie 107 does require an evening walk between 8 and 10 hours after her morning walk. Because the user 102 does not have a set time to leave in the morning, the time that the user leaves home is needed every day if the mobile application 101 is to determine if the user 102 will arrive home in time to walk Minnie 107. If the user enters into the mobile application 101 his home location, either by entering an address or logging a GPS position while at home, the mobile application 101 may determine each morning when the user 102 has moved more than a predefined distance away from the home 103. The mobile application 101 may use this time data as a trigger to determine when the time has reached a notification event time. This notification event time will occur 9 hours after the start trigger event, assuming the user set the mobile application 101 to use 9 hours as the used time length value.

Throughout the rest of the day, the user may go about his or her business while the mobile application 101 waits for the notification event time to arrive. The mobile application 101 may periodically use the user's location to determine whether there is enough time for the user 102 to arrive at home 103 before the notification event time occurs. The mobile application 101 may obtain traffic data from various on-line services such as Google Maps™, Apple Maps™, or GPS providers such as Tom-tom and Garmin that may be used in the estimation of the travel time between the user's current location and home 103.

When the mobile application 101 determines that the user 102 will not arrive at home before the notification event time occurs, the mobile application 101 may generate one or more notification messages. The mobile application 101 may generate an on-screen notice to the smartphone user 102 101a stating that he or she will be late arriving home to walk Minnie 107. The mobile application 101 may also send a notification to the user's neighbor Quinton 121, that the user 102 will not be home before the notification event time and that Minnie 107 needs a walk. If the user 102 has made arrangements for Quinton 121 to walk Minnie 107 occasionally, Quinton may use this notification to assist the user and Minnie 107. The mobile application 101 may communicate with Quinton 121 by sending an email to a previously entered email address, by sending a SMS message to a smart phone 121a, or to call a phone number with a recorded message. Any or all of these forms of communication may provide Quinton notification of the need to walk Minnie 107.

A similar event notification may be generated should the user 102 go missing for more than a specified time period, for example 48 hours. The user 102 may be assumed to be missing if the smartphone 101a has been turned off or has run out of battery power for more than this time period. In such a circumstance, a Web server 115 may perform the above process.

In this alternate embodiment, the mobile application 101 routinely communicates with the Web server 115 over the Internet 110 to provide the Web server 115 upcoming start triggering events as well as status updates that may include a present position. If the smartphone 101a is damaged or turned off, the Web server 115 will stop receiving these status updates from the mobile application 101. Failure to receive status updates for a set period of time may inform the Web server 115 to perform the upcoming event notification events. The web server 115 may determine when a notification event time will occur based upon the recent status update data received from the mobile application 101. When these notification event times occur, the Web server 115 may send the notification messages as defined within the mobile application 101. In the case of the user 102 thought to be missing for more than 48 hours, a message may be sent to authorities to investigate the fact that the user 102 has not been present. In the case of walking Minnie 107, the Web server 115 may send the same notification message to Quinton 121 that the mobile application 101 would have sent if it was operating.

All of these notifications may be sent to one or more destinations by one or more of the supported messaging mechanisms as defined by the user 102 within the mobile application 101. In most cases, the mobile application 101 is expected to be operating so that the Web server 115 typically acts as a backup service. In some embodiments, the Web server 115 is not provided and only notifications generated by the mobile application 101 will be generated. The user 102 may enter as many events as desired into the mobile application 101 with each one being processed independently of each other. Additionally, the user 102 may disable the operation of these events for a period of time, such as may occur when the user 102 is traveling on vacation. When the user 102 returns home 103, the events may be reactivated again.

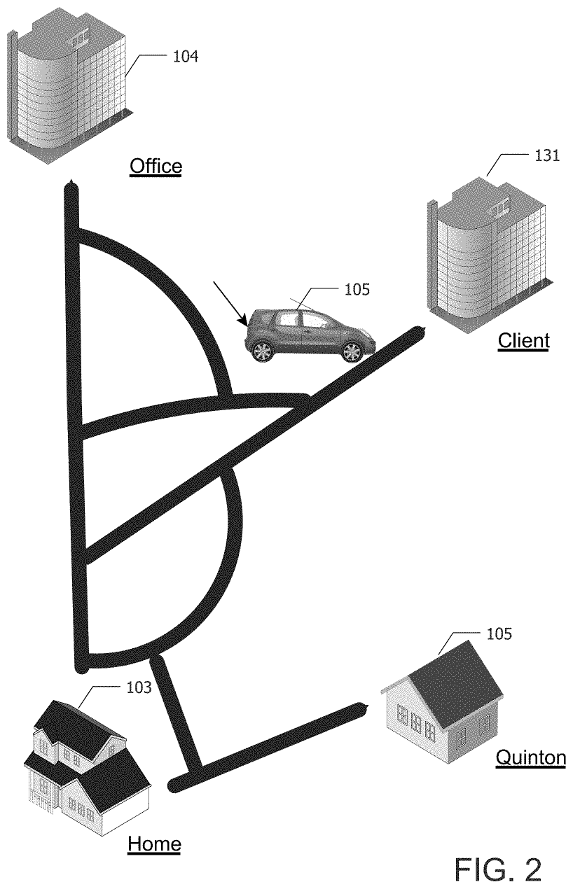

FIG. 2 illustrates an example use of a system that provides that provides real-time automated location-based alerts of time-based events according to the present invention. FIG. 2 presents a simplified map of the town where the user 102 typically is located. The user's home 103 and the user's office are shown as is Quinton's home 105. The mobile application 101 is provided with these locations and will be able to determine when the user 102 and the smartphone 101a running the mobile application is in any of the locations. Similarly, the mobile application 101 will be able to determine when the user 102 and the smartphone 101a are moving in a car 105. The mobile application 101 may use the current location in the car 105 to determine whether sufficient time exists to arrive at a location before an upcoming notification event is to occur.

Consider an example in which the user 102 has scheduled an important meeting with a client on Apr. 1, 2020 at 1:00 pm. The meeting is scheduled to occur at the client's office at a known address. The 1:00 pm meeting may be treated as an upcoming triggering event that the mobile application is to process. Additionally, the meeting may be set to require the user to arrive at least 15 minutes before the start of the meeting. Using this data, the mobile application 101 may determine from the user's current location if it is possible to arrive at the client's address at least 15 minutes before 1:00 pm on Apr. 1, 2020.

If the mobile application 101 determines the user may be late, the mobile application may generate any notifications that the user 102 defined for the meeting event. The mobile application 101 may generate an on-screen notification to the user on the smartphone 101a. The mobile application 101 may send one or more messages to the user's assistant to allow the assistant to notify the appropriate individuals and/or seek someone else to cover the meeting. Similar notification messages may be sent to the client, if appropriate, that the user 102 is running late. The user 102 may determine which notification messages are sent to various individuals as needed.

These notification events may be useful in work situations such as: teachers who need a substitute, attorneys who are expected in court for a hearing or trial, healthcare professionals expecting to see patients, and many other similar situations. The notification events may also be useful for parents monitoring a child to determine if he/she: made it back to a dorm on a particular evening, made it to work on time, attended an important appointment or arrived at a specified time to pick someone up at work, the airport, the train station and the like.

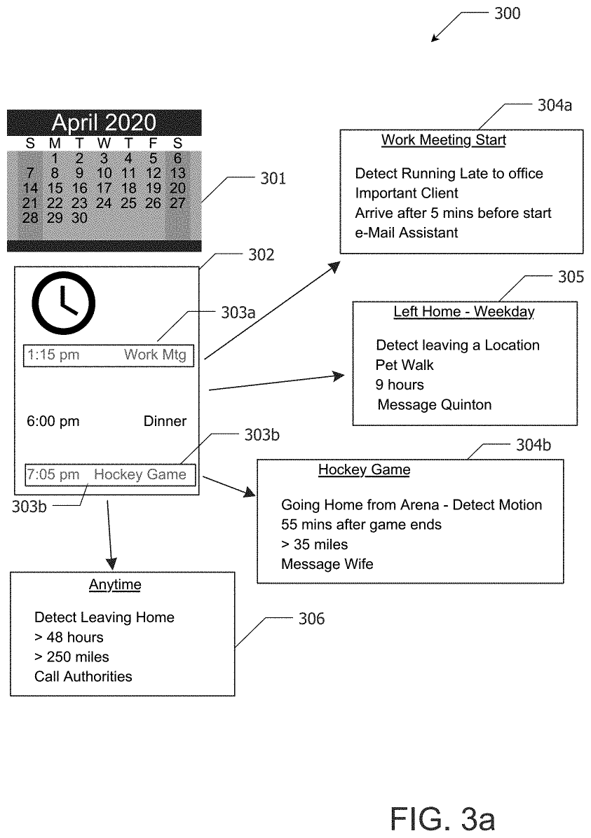

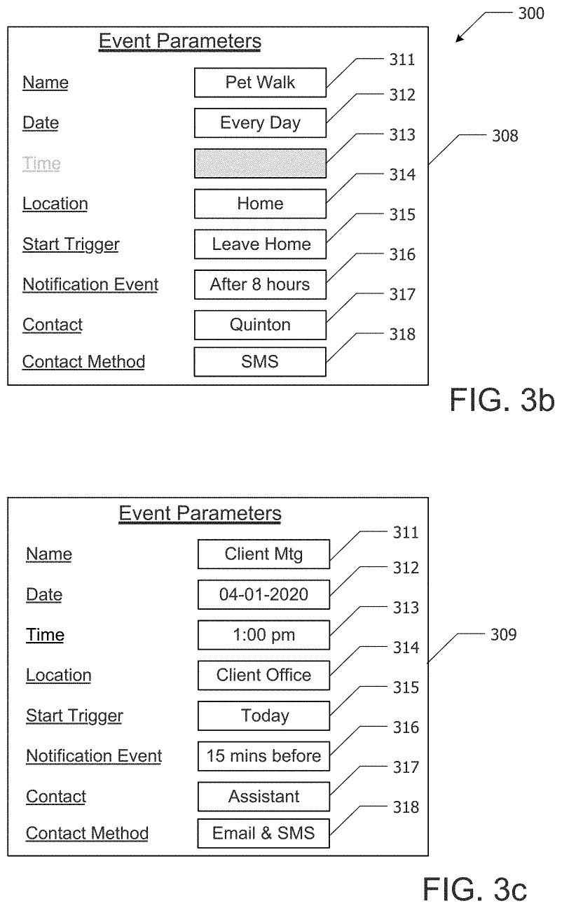

FIGS. 3a-c illustrate example event embodiment useful in a system that provides real-time automated location-based alerts of time-based events according to the present invention. A calendar 301 showing a set of appointments 302 for one particular day is presented in FIG. 3a. This calendar 301 may be part of the mobile application 101 or may reference appointments from an external calendar application. Most smartphones 101a include a default calendar application as well as provide additional applications for installation via an app store for the smartphone.

Two of the appointments 303a-b on the day shown 302 are associated with notification events 304a-b in the mobile application 101. A 1:25 pm work meeting 303a is associated with a notification event work meeting start 304a. A 7:05 pm hockey game is associated with a notification event hockey game 304b. Each of these notification events list at least a triggering event that the mobile application detects, a name for the event, a notification event time relative to the triggering event, and a stated action to occur if notification messages are required. These events behave in the same manner as discussed above.

Two additional notification events, Left Home Weekdays 305 and Missing Anytime 306, are also shown. Left Home Weekday 305 corresponds to the walking Minnie 107 example discussed in reference to FIG. 1. Missing Anytime 307 corresponds to the gone missing 48 hours when the smartphone 101a stops communicating and ends with notification provided to the authorities as discussed above.

Using these constructs, any event that is based upon starting and/or ending at a location that is to occur at a stated time may be defined. Locations may be used to determine if the user 102 arrives or leaves a location. The arrival and departure events may be used as a start trigger event or may be used as a notification event that should occur by a stated time.

FIG. 3b illustrates an event record 301 that is defined by the user 102 within the mobile application. FIG. 3b is the “Walk Minnie” 107 event discussed herein. The event record 308 includes a name field 311, a date field 312, a location field 314, a start trigger event with location 315, a notification event relative to the start trigger event 316, a contact to receive notification 317, and a notification method 318. Because the date field 312 states that this is an every day event, a time field 313 is shown grayed out as not being applicable. As explained above, the triggering event occurs when the user 102 leaves home 103. The notification event occurs 9 hours later. If a notification event occurs, an SMS message 318 is sent to Quinton 317.

FIG. 3c illustrates an event record 309 for the client meeting discussed above in reference to FIG. 2. The triggering event 316 is today. Today refers to the stated date 312 and time 313 found in the event record 302. The notification event 317 is 15 minutes before the start of the meeting. The location 314 where the user 102 needs to be before the notification event occurs is identified as the client's office. The mobile application 101 may use the client's address as listed in a contact record for the client stored within an application in the smartphone 101a. The mobile application 101 may also allow the user 102 to directly enter a location or address into the event record 309 if desired. If the notification event occurs, an email message and an SMS message 318 are sent to the user's assistant 317 as defined in the mobile application 102 or in a contact record for the assistant listed elsewhere.

The user 102 may create an event record 308-309 within the mobile application 101 by associating the event record with a calendar appointment and entering the appropriate values. If the calendar event exists already, the name field 311, date field 312, time field 313 and location field 314 may be prepopulated using data from the calendar appointment if it is present. The other fields may be entered by the user 101 as desired. In a preferred embodiment, predefined and recognized values for use in these fields may be selected by the user 101 from items provided in a pop-up list. Use of the pop-up list (not shown) helps ensure that the values entered may be properly interpreted by the mobile application. For example, the notification event field 316 may be constructed using a set of terms such as “>,” “before,” “after,” or “at exactly” followed by a numeric value that is followed by a units value such as “minutes,” “hours” or “days.” Additionally, the contact person in field 317 may be provided from a list of names in which email addresses, cell phone numbers, and the like are known. The contact method 318 may provide a list of supported methods available to the mobile application 101 on the smartphone 101a. Users 101 may also define other items in these pop-up lists so that the mobile application 101 may receive a defined method to determine how the values entered are to be used.

Multiple event records 308-309 may be associated with the same calendar event 303a. For example, the client meeting of FIG. 3a may have an event record that sends a notification message to an assistant 30 minutes before the notification event to permit the assistant to attempt to intervene. A second event record for the client meeting may send an urgent notification message at 5 minutes before the meeting to a trusted partner who could attempt to contact the client to protect the client relationship. Users may choose to create and use the event records and corresponding notification messages as desired.

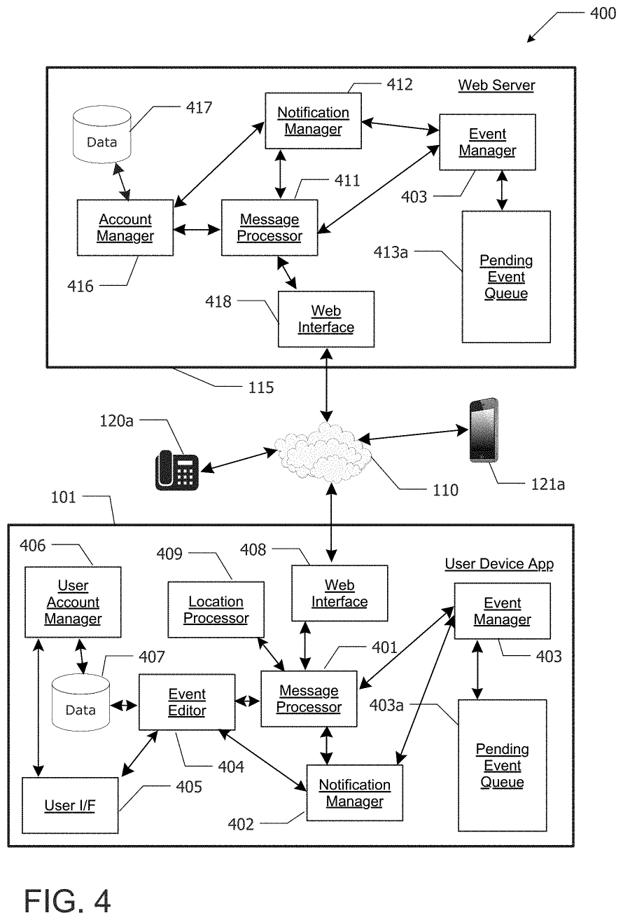

FIG. 4 illustrates a computing system of software components that provides real-time automated location-based alerts of time-based events according to the present invention. The location based event notification system uses a mobile application 101 running on a user device 101a and may possibly use a Web server 115 connected to users 101a, 120a via the Internet. The user device 101a typically monitors and generates notification messages as appropriate. The Web server 115 typically acts as a backup for the user devices should the user devices go offline. Users create, edit, and maintain event records used by the mobile application 101 and the Web server 115 to generate the notification messages.

The mobile application is constructed using a message processor 401, a notification manager 402, an event manager 403, a pending event queue 403a, an event editor 404, a user interface 405, a user account manager 406, a local datastore 407, a user device Web interface 408, and a location processor 409.

The message processor 401 acts as a central controlling processor. The message processor 401 receives messages from other applications and from remote devices and passes the messages to the appropriate processor within the mobile application 101 to generate a response. The message processor 401 sends any notification messages generated by the notification manager 402 to email servers, SMS message gateways, and other remote destinations.

The notification manager 402 receives indications of the occurrence of a notification event from the event manager 403. The notification manager 402 retrieves the event record from the local datastore 407 to obtain the type of notification message that is needed and its destination. The notification messages are then generated by the notification manager 402 before being passed to the message processor 401 for transmission to the named destination.

The event manager 403 having a pending event queue 403a retrieves any upcoming events that are scheduled to occur in the upcoming day or days. The event manager 403 retrieves the listed appointments from a calendar dataset and identifies which, if any, of the listed appointments possesses corresponding event records. These event records are retrieved from the local datastore 407 and start trigger events and notification events are determined. The start trigger events and the notification events are stored into the pending event queue 403a. The event manager 403 retrieves current location data from the location processor 409 as needed to determine whether or not a pending start trigger event is to occur. Once the start trigger event occurs, the event manager 402 monitors the current location and current time to determine whether a notification event occurs. If the location processor 409 indicates that an active event has reached its desired location before a notification event occurs, the event manager 403 marks the event completed and removes any associated data from the event from the pending event queue 403a.

The event editor 404 permits users to create, modify, and delete an event record. The user provides input to the mobile application via the user interface 405. Editing event commands are provided to the event editor 404 for processing. If the editing event commands refer to an existing event record, the event editor 404 retrieves the event record from the local datastore 407. The event editor 404 sends information regarding the event record being edited to the user via the user interface 405. The event editor 404 receives responses and commands from the user via the user interface to add, modify, and delete data from the event records. Once the editing is completed, the modified event record is stored back into the local datastore 407. For new event records, the event editor starts with a blank event record and populates its fields based upon user input via the user interface 405. Once complete, the new event records are stored into the local datastore 407. All edited and new event records are also sent to the event manager 403 to determine if the new or edited event record corresponds to an active event when the start trigger event has occurred or to determine if the event record should also be added to the pending event queue for tracking as required. All future processing of event records by the event manager 403 uses the edited or new event records.

The user account manager 406 processes user account information, including username, password, address, phone number, and payment information necessary for the mobile application to log into and communicate with the Web server 115. The user 102 uses the user account manager 406 to create a user account on the Web server 115. The user account manager 406 maintains user account information to periodically authenticate itself with the Web server 115. This user account may be used by the Web server 115 to only provide backup event notifications on behalf of users who have registered their mobile applications 101 and user devices or smartphones 102a with the Web server 115. If the Web server 115 requires a subscription and periodic payment to maintain the Web server 115 and user account to act as a backup notification service on behalf of the user 102, payment information from the user account manager 406 is sent to the Web server for processing.

The location processor 409 uses GPS data, cellular service cell tower location data, and/or Wifi location data to determine a current location for the smartphone 101a for use by other components in the mobile application. The location processor 409 receives the GPS data from a GPS receiver in the smartphone 102a, receives cell tower location data from a cell phone transmitter/receiver, and receives Wifi location data from a Wifi module in the smartphone 102a. The location processor 409 uses any or all of the above data sources that are currently available to determine an estimated location using each data source. If the estimated locations are the same, or similar within an acceptable level of error, one of the estimated locations is reported as the current location for use within the event processor 403 and the notification processor 402. If the estimated locations do not agree, the location processor 409 will attempt to determine which of the estimated locations is most likely using the number of sources, i.e. number of GPS satellite signals received, the number of cell tower location signals received, the signal strength of all received signals, and the identity of trusted data. For example if a trusted Wifi network is active and its location is known and trusted, the estimated location from the Wifi location data may be viewed as accurate.

The user device Web interface 408 connects the mobile application 101 to the Internet 110. All communications between the mobile application 101 and remote devices, including the Web server 115 and contact's devices 120a-121a that use the Internet 110 are processed by the user device web interface 408. The user device web interface 408 formats and converts any data into an appropriate format depending upon the type of communications channel in use to connect the smartphone 102a to the Internet, i.e. Wifi, LTS cellular, local ethernet and the like.

The mobile application is constructed using a server message processor 411, server notification manager 412, server event manager 413, pending server event queue 413a, server account manager 416, system datastore 417, and user device Web interface 418. All of these components provide the same functionality as the corresponding component within the mobile application 101. The only difference between the functionality of these corresponding components is that the server components 411-418 act only on events from user smartphones 102a and mobile applications 101 that currently are not online.

The server event manager 413 will periodically communicate with the message processor 401 in the mobile application 101 when a start trigger event and a notification event are to occur to check if the mobile application 101 is online. If the message processor 401 responds to the periodic communication, the server event manager 413 takes no further action. If the message processor 401 does not respond to the periodic communication, the server event manager 413 acts in place of the mobile application 101. When the mobile application 101 returns online, the message processor 401 will send a message to the server message processor 411 providing notification of the mobile application's return. The server message processor 411 informs the server event manager 413 of the online return of the mobile application 101 so that the server event manager 413 may terminate monitoring any events related to missing user devices 102a.

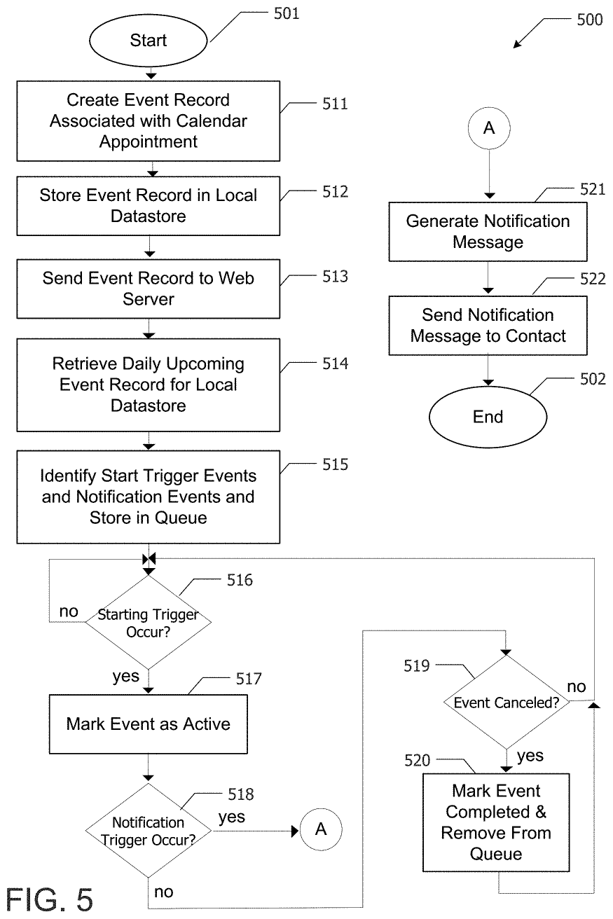

FIG. 5 illustrates a flowchart corresponding to a method performed by software components that provides real-time automated location-based alerts of time-based events according to the present invention. The process begins 501 when an event record associated with a calendar appointment is created in step 511. The user 102 inputs all necessary data to define the event with some of the event data starting from prepopulated data found in the calendar appointment. The event record is saved into the local datastore 407 in step 512. A copy of the event record is sent to the web server 115 in step 513 as the web server is acting as a backup process for the mobile application 101 when the smartphone 101a is offline.

In step 514, any upcoming event records are retrieved from the local datastore 407 so that upcoming start trigger events and upcoming notification events may be generated and stored, in step 515, into the pending event queue 403a. Once the upcoming events are in the pending event queue 403a, test step 516 waits until a time corresponding start trigger is reached. Step 517 marks the event as being active for use in determining whether a notification event will occur.

Test step 518 determines if a notification event has occurred, and if not, test step 519 determines whether the event associated with the active event has been cancelled by the user 102 arriving at the event location. If the event has been cancelled, step 519 marks the event record as being completed and all associated data for the event is removed from the pending event queue because a notification message is not needed for this event. In either case, the process returns from test step 518 to test step 516 to await for the next upcoming start trigger event to occur.

Returning back to test step 518, if the test step determined that a notification message is needed, step 521 generates the notification message in the appropriate format for a designated communications medium. The notification message is sent to the named contact using the contact information from the event record in step 522 before the process ends 502. This entire process is repeated for each event record generated and then retrieved from the local datastore 407 for processing as long as an upcoming start trigger event, or an upcoming notification event is within the pending event queue 403a.

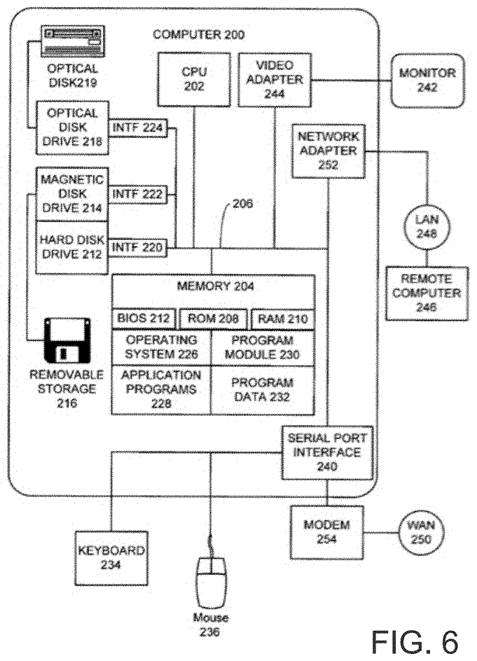

FIG. 6 illustrates a generalized schematic of a programmable processing system utilized as the various computing components described herein to implement an embodiment of the present invention. The central processing unit (“CPU”) 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (1/0) adapter 210, a communications adapter 214, a user interface adapter 216, and a display adapter 222. The 1/0 adapter 210 and/or the user interface adapter 216 may, in certain embodiments, enable a user to interact with the computer system 200. In a further embodiment, the display adapter 222 may display a graphical user interface (GUI) associated with a software or Web-based application on a display device 224, such as a monitor or touch screen.

The 1/0 adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the 1/0 adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth™ network. The user interface adapter 216 couples user input devices, such as a keyboard 220, pointing device 218, and/or touch screen (not shown) to the computer system 200. The keyboard 220 may be an on-screen keyboard displayed on a touch panel. Additional devices (not shown) such as a camera, microphone, video camera, accelerometer, compass, and/or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of computer system 200. Rather the computer system 200 is provided as an example of one type of computing device that may be adapted to perform the functions of a real-time automated location-based alerts system, including servers, personal computers, and mobile devices as shown in FIG. 3. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included with this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), server(s) computer system(s) or Web application(s) required to allow: communication, control (including but not limited to control of parameters and settings), and transfer of content(s) or data between any combination of the components.

What is claimed is:

1. A system for providing real-time automated location-based alerts of time-based events, the system comprising:
a mobile application for defining an event record associated with a calendar appointment and for processing event records as event triggers and notification events occur;
a web server for maintaining a database of event records periodically provided to the mobile application for monitoring;
wherein the mobile application sets an event record as being active when a trigger event occurs;
the mobile application send a notification message to a recipient when a notification event associated with the active event record occurs; and\
the active event record is deleted when a condition associated with the calendar event is satisfied before a notification event occurs.

2. The system according to claim 1, wherein the condition associated with the calendar event being satisfied is met when the mobile application detects its geo-position location being at a location for the calendar event.

3. The method according to claim 1, wherein the recipient of the notification message is identified in the event record; and
the notification message comprises an email, and SMS message, an instant message; and a recorded phone call.

4. A method for providing real-time automated location-based alerts of time-based events, the method comprising:
creating an event record associated with a calendar appointment;
storing the event record in a local database;
transmitting the event record to a web server;
retrieving daily upcoming event records from the local database;
identifying a start trigger event and notification event associated with the daily upcoming event records;
storing the start trigger event and the notification event into a queue;
when a trigger event occurs, mark the daily upcoming event records associated with the trigger event as an active event; and
when a notification event occurs associated with the daily upcoming event records marked as active, generating a notification message and sending the notification message to a recipient.

5. The method according to claim 4, wherein the method further comprises:
marking the daily upcoming event record in the queue as being cancelled; and
deleting the daily upcoming event record in the queue marked as cancelled.

6. The method according to claim 5, wherein cancelling an active event record occurs when a condition associated with the calendar event is satisfied before a notification event occurs.

7. The method according to claim 6, wherein the condition associated with the calendar event is satisfied is met when the mobile application detects its geo-position location being at a location for the calendar event.

8. The method according to claim 4, wherein the recipient of the notification message is identified in the event record; and
the notification message comprises an email, and SMS message, an instant message; and a recorded phone call.
